(19) United States
(12) Patent Application Publication
(10) Pub. No.: US 2022/0114914 A1
(43) Pub. Date: Apr. 14, 2022

(54) INSTANT DEFINITION DISPLAYING METHOD FOR UNKNOWN TERMS DURING READING ANY TEXTUAL INFORMATION

(71) Applicant: Basil GENESIS, Moscow (RU)

(72) Inventor: Basil GENESIS, Moscow (RU)

(21) Appl. No.: 17/498,056

(22) Filed: Oct. 11, 2021

Related U.S. Application Data
(60) Provisional application No. 63/091,081, filed on Oct. 13, 2020.

(51) Int. Cl. G09B 19/08; G06F 40/51; G06F 40/30; G06F 40/47

(52) U.S. Cl. CPC G09B 19/08; G06F 40/47; G06F 40/30; G06F 40/51

(57) ABSTRACT

A system and method for tracking definitions for unfamiliar terms in the process of reading foreign literature. Allows you to quickly absorb large amounts of textual information by international groups of people who are not native speakers of the language in which this information is presented. It serves as a unifying link between intensive and extensive types of reading, which allows you to increase the efficiency of the educational process, as well as quickly adapt to an unfamiliar social environment.

### CROSS-REFERENCE TO RELATED APPLICATIONS

The present patent application claims priority to U.S. provisional application No. 63/091,081 filed on Oct. 13, 2020, which is fully incorporated herein by reference.

### FIELD OF THE INVENTION

This invention is part of a special software and applies to any digital media device with a display (for example, a computer or mobile devices). The main field of application of this invention is the translation of texts in a foreign language.

### BACKGROUND OF THE INVENTION

Between reading and the cognitive capabilities of a person, there is a clear relationship that allows you to develop creativity and imagery of thinking. High-quality literature allows you to diversify speech with new words and expressions, which are almost impossible to meet in everyday life. Through reading, the most faster is the build-up of the intellectual base of a person, as well as reading reduces emotional stress and makes it easier to find inner harmony. Therefore, reading, at the moment, is one of the most important fundamental reasons, which is an integral part of the educational process and especially if it concerns such a subject as the study of foreign languages.

Learning foreign languages in the world is divided into two groups of people.

The first group is local or international students who constantly experience difficulties in obtaining education when it involves reading literature in a language other than their native language.

The second group is not students who have set themselves the task of learning one or more foreign languages and the main problem they face is the inability to start reading books in a foreign language from the very beginning of their studies.

One problem unites these two groups—a low level of vocabulary, which turns the reading process into a battle with the learning material.

International students are particularly uncomfortable, as practicing reading is the most effective way for them to learn to speak fluently, but the lack of reading skills puts them in an unprivileged position compared to native speakers. This situation practically destroys any attempts for social integration, since it often leads to irritation and complexity in students of non-native speakers of the language and as a result the learning process suffers. It does not matter how well the curriculum is adapted to international students, as the practice of reading greatly limits it. It is very difficult to imagine the study of foreign languages without the possibility of reading outstanding representatives of these languages in the original language. Therefore, many teachers are unable to complete many reading programs because non-native students simply cannot complete them.

In order for an international student to fully comprehend the educational process, there are only two practices of reading in a foreign language—this is intensive and extensive reading.

Intensive reading is a type of class reading and implies a detailed reading of short fragments of text to obtain specific information. Intensive reading is important for understanding every word in the text, understanding sentence structure, semantics details, and also focuses on grammar.

Extensive reading is extracurricular reading and is used to gain a general understanding of the subject and involves reading long texts for pleasure using a relatively small vocabulary. Since it is important to understand not each word separately, but to be able to catch the general meaning of the sentence.

Both types of reading cause fear in non-native students, since vocabulary in both cases is a fundamental circumstance to read and speak a foreign language fluently, and reading is the only effective method for acquiring vocabulary. Therefore, international students are constantly faced with such a contradiction in education and at the same time there are no serious tools that will allow them to read freely in a foreign language in educational programs.

Despite the fact that in the world, at the moment, there are a large number of software tools that make it possible to facilitate the process of reading foreign literature, but the methods that are used in them are not comfortable for achieving a large vocabulary in a short time. In all these applications, the reader must perform a number of tedious actions while reading books such as: copying or writing unfamiliar terms, actively working with the dictionary, working with flash cards to study a set of words. The next time the reader encounters an unfamiliar word in the text, he is again forced to turn to the dictionary, as a result of which the reading process turns into an irritable routine that you want to avoid.

Also, the student does not have the opportunity to choose to read foreign literature according to his level of training or desire, since all the assistants presented to date for reading foreign literature do not give the opportunity to choose literature, but only use books prepared in advance. And it is important to note that none of the existing tools can be considered as a professional means for learning a foreign language through reading, since they are very limited in their capabilities, and therefore, no university recognizes them as a full-fledged tool that can get rid of many international students discomfort in mastering foreign literature.

Therefore, at the moment we can conclude that in the world there is no universal means for reading any foreign literature that would allow you to work comfortably with the text and would contribute to an active increase in vocabulary. As a result, there is a need to create a tool that would allow becoming part of the educational process not only for international students, but also would help other groups of people to get comfortable access to any foreign literature.

### SUMMARY

The present invention is aimed at significantly facilitating the process of learning foreign languages through reading and increases the level of understanding of text material several times in comparison with other existing practices.

This invention allows you to combine intensive and extensive reading and as a result of which the level of vocabulary of the applicant increases several times after reading at least one book.

This invention allows you to avoid unnecessary and time-consuming actions with the text, as it automatically translates in the text any words, phrases, grammatical constructions, idioms, etc.

It is enough once for the user to add an unfamiliar text term to the database and its meaning will constantly be automatically highlighted when this term is encountered in the text again.

This invention allows you to study all unfamiliar text terms in the context of the sentence, without being distracted by working with additional dictionaries and increases the efficiency of perception of unfamiliar information. The user can not only intensively analyze complex grammatical constructions, but also enjoy reading literature in an unfamiliar language.

### BRIEF DESCRIPTION OF THE DRAWINGS

FIG. 1 shows an illustrative embodiment of a system with which the invention may be employed.

### DETAILED DESCRIPTION

This invention allows displaying the definition (translation) of the unknown terms (words, collocations, phrases, sentences and other signs, hereinafter “Terms” or “Term”) in a special way inside any textual information (hereinafter “Original Text”) during the reading on any digital media screen.

The necessary components are:
Any digital media with display (for example, computer, mobile devices)
“Original Text” (any book, textbook, document, news information, note, etc.)
Specific software for reading “Original Text”
Definition (for example, translation, meaning, explanation, description, the signification of “Term” or “Terms”, hereinafter “Definition” or “Definitions”)
Source of Definition (for example, dictionary, database, glossary, lexicon, wordbook, thesaurus, vocabulary, hereinafter “Source of Definition” or “Source of Definitions”)

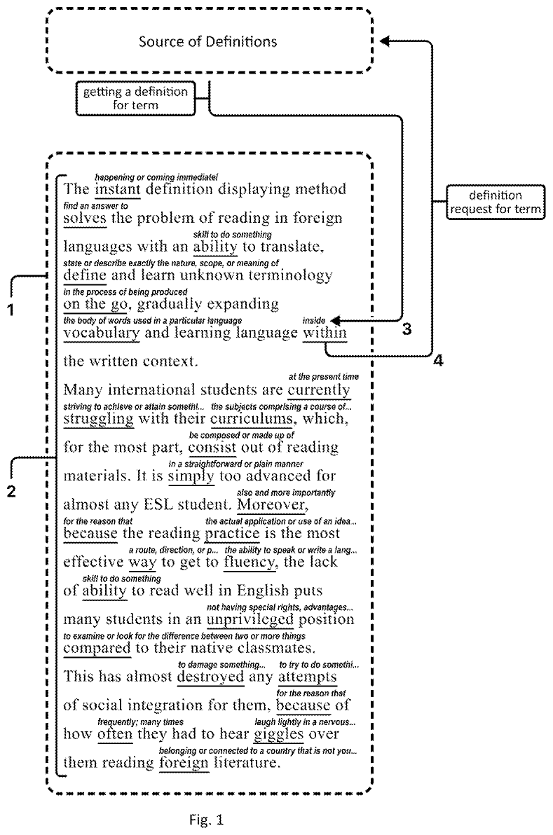

FIG. 1 shows a special program interface that allows you to explain the invention. The conditional “Original text”, which is shown in FIG. 1 is presented for understanding the invention.

All underlined text in “Original Text” is abstract “Terms” for example. All the text that is located above the abstract underlined “Terms” is abstract “Definitions” also for example.

The basic idea of a patent is that when you read any “Original Text” (number 2, FIG. 1) and see the “Term” (number 4, FIG. 1), which is also located in the “Source of Definition”, “Definition” of the “Term” from “Source of Definition” will appear above the “Term” (number 3, FIG. 1) without any additional actions with “Original text” by a user.

At the FIG. 1 can be seen the instant “Definition” (“Definitions”) displaying method for all “Terms” simultaneously, which have “Source of Definitions” references. This method allows you to show both: one selected “Definition” or many “Definitions” in the “Original text”.

It can be used not only for reading any “Original Text”, but it can also be used for getting the “Definition” (“Definitions”) for any symbols, formulas, signs and other textual information.

The user does not need to constantly translate any “Terms” in the “Original text”, as is done in existing systems for reading foreign literature. The main thing is to add an unfamiliar “Term” with “Definition” to “Source of Definitions” only once and when the added “Term” occurs in the “Original Text” again, it will be identified as a “Term” that has a “Definition” and this “Definition” will be shown above the added “Term”.

It doesn't matter how “Terms” with “Definitions” are added to “Definition Source”.

What is claimed is:

1. A method for displaying a meaning of an unknown term while reading a text, comprising:
marking the unknown term;
receiving a displayed definition of the marked term;
saving the term and the definition in a user vocabulary file in a computer.

2. The method of claim 1, wherein the computer in a hand-held reading device.
